(19) United States
(12) Patent Application Publication
(10) Pub. No.: US 2013/0074032 A1
(43) Pub. Date: Mar. 21, 2013

(54) APPLICATION DEVELOPMENT SERVER

(71) Applicants: Pedro Pablo Barragán Barragán, Mexico City (MX); Rodrigo de Jesus Gómez Galaz, Mexico City (MX)

(72) Inventors: Pedro Pablo Barragán Barragán, Mexico City (MX); Rodrigo de Jesus Gómez Galaz, Mexico City (MX)

(21) Appl. No.: 13/237,503

(22) Filed: Sep. 20, 2011

(51) Int. Cl. G06F 9/44

(52) U.S. Cl. 717/101

(57) ABSTRACT

Methods and systems are disclosed for a server for app development. The server includes a memory, a network communication interface, and a controller. The controller is configured to receive user input from users of the electronic devices, the user input indicative of requests for searches of the stored profiles, send results of the searches of the stored profiles to the users of the electronic devices, receive requests from the users to send invitations to other users to join a virtual app development team, send invitations to the other users to join the virtual app development team, receive acceptance information from one or more of the other users, create a virtual app development team based on the acceptance information, and configure a section in the memory accessible to the virtual app development team and dedicated for development of an app.

### BACKGROUND

An app is an abbreviation for a software application. The app is a piece of software, which can run on (i) the Internet, (ii) a non-portable computer (such as, for example, a desktop computer), (iii) any operating system (OS) App compatible portable electronic device (such as, for example, phones, cellphones, smartphones, laptop computers, electronic tablets, cameras, etc.), (iv) any OS App compatible non portable device (such as, for example, home appliances or televisions), or (v) any OS App compatible semi portable embedded device (such as, for example, those found in transportation vehicles), with (ii) through (v) referred to as “OS App Compatible Devices” or “OS App Compatible Device”. For example, apps may be designed for various Apple® products, such as the iPhone® smartphone, iPad® tablet computer, iTouch® media player, for various needs relating music, traveling, social networking, sports, etc.

Apps may be sold using a platform as part of an online application store or other type of online retail establishment. One example is the Apple® App Store, which provides a single point of access for Apple-applicable apps. Other single points of access include the Google® Android® Market and Nokia® Ovi® Store, among others. Platforms typically allow users to browse and download applications. The applications can be downloaded directly to an OS App Compatible Device.

The downloading of apps has been incredibly successful. The Apple® App Store alone has had approximately fifteen billion applications downloaded. Moreover, the number of apps available has exploded, both in number and in diversity of applications. Typically, the online application store receives 30% of revenue, and the developer receives 70% of the revenue from the sale of an app. Further, the online application store will market the various apps, determining what is worthy of promotion. While this business model has been successful in expanding the market for apps, this model is limited in terms of the ability to develop and market new apps. Therefore, a need exists to better develop and market apps.

### SUMMARY

In order to address problems related to apps, a server is disclosed that relates to development of an app. The server includes a memory, a network communication interface, and a processor in communication with the memory and the network communication interface. The memory is configured to store profiles for one or more of innovators, developers, investors, entrepreneurs, consumers, testers enterprises, and any other person involved in the development of an app, the profiles including data for a respective innovator, developer, investor, entrepreneur, consumer, tester, enterprise or any other person involved in the development of an app. The network communication interface is configured to receive communications with one or more electronic devices. The controller is configured to receive user input from users of the electronic devices, the user input indicative of requests for searches of the stored profiles, send results of the searches of the stored profiles to the users of the electronic devices, receive requests from the users to send invitations to other users to join a virtual app development team, send invitations to the other users to join the virtual app development team, receive acceptance information from one or more of the other users, create a virtual app development team based on the acceptance information, and configure a section in the memory accessible to the virtual app development team and dedicated for development of an app.

A method is disclosed that relates to development of an app through a server. The method includes: receiving user input from users of the electronic devices, the user input indicative of requests for searches of the stored profiles, the stored profiles for one or more of innovators, entrepreneurs, developers, consumers, enterprises, investors and any other person involved in the development of an app, the stored profiles including data for a respective innovator, developer, investor or any other person involved in the development of an app; sending results of the searches of the stored profiles to the users of the electronic devices; receiving requests from the users to send invitations to other users to join a virtual app development team; sending invitations to the other users to join the virtual app development team; receiving acceptance information from one or more of the other users; creating a virtual app development team based on the acceptance information; and configuring a section in the memory accessible to the virtual app development team and dedicated for development of an app.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 illustrates one example of an environment for the Collaborative App Development Platform Server.

FIG. 2 illustrates one example of an expanded block diagram of Collaborative App Development Platform Server.

FIG. 3 is an illustration of the business model value chain for an app, as part of the Collaborative App Development Platform Server.

FIG. 4 is an expansion of various stages of the app life cycle within the Collaborative App Development Platform Server.

FIG. 5 is a high level flow chart of various steps in the development and marketing of an app, as part of the Collaborative App Development Platform Server.

FIG. 6 is a more detailed flow chart of the various steps in the development and marketing of an app, as part of the Collaborative App Development Platform Server.

FIG. 7 is an illustration of various value added functions that the Collaborative App Development Platform Server may perform, as part of the Managed App Services features (as defined below).

FIG. 8 is a flow diagram of revenue management for apps managed pursuant to the Managed App Services features (as defined below) of the Collaborative App Development Platform Server and optionally funded through the Collaborative App Development Platform Server.

FIG. 9 is a general computer system, programmable to be a specific computer system, which may represent any of the computing devices referenced herein.

### DETAILED DESCRIPTION

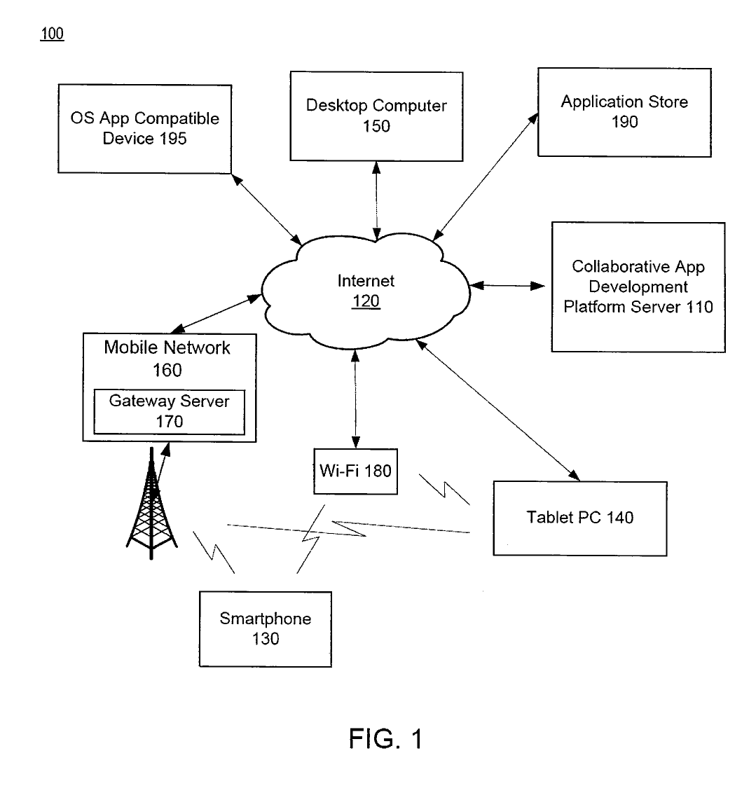

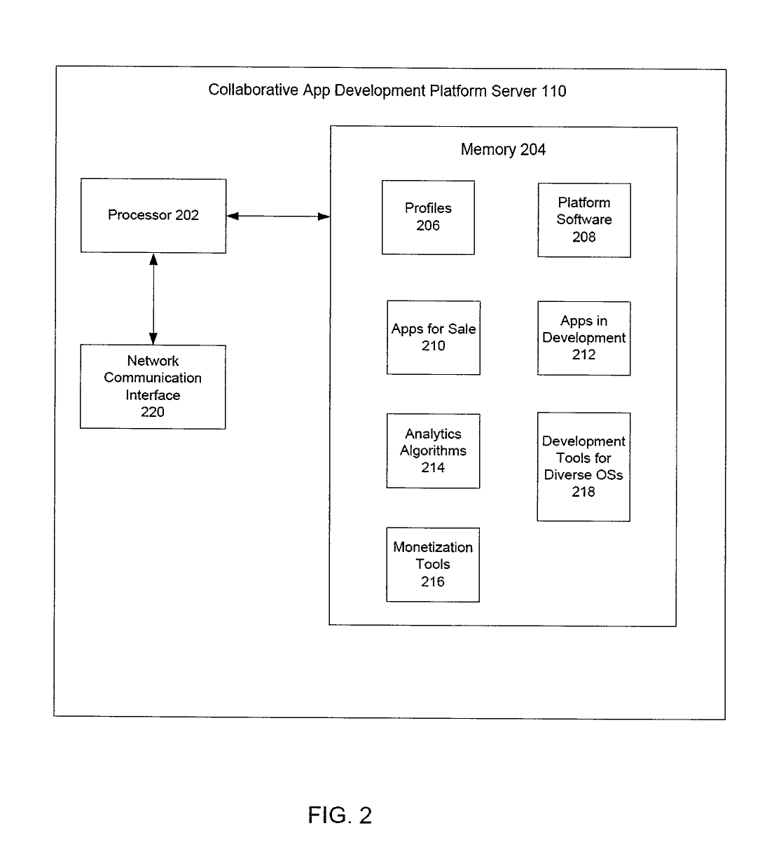

FIG. 1 illustrates one example of an environment 100 for the Collaborative App Development Platform Server 110 (hereinafter referred to as the “Platform”). The Platform 110 may communicate with one or more Application Stores and any OS App Compatible Device, such as smartphone 130, tablet PC 140, and desktop computer 150. The examples of smartphone 130, tablet PC 140, and desktop computer 150 are merely for illustration purposes. Any and all OS App Compatible Devices may be used. Other computing devices, such as those included in the definition of OS App Compatible Devices, are contemplated to communicate with the Platform 110. Further, while only a single smartphone 130, tablet PC 140, and desktop computer 150 are illustrated in FIG. 1, it is contemplated that the Platform 110 may communicate with multiple OS App Compatible Devices. As discussed in more detail below with respect to FIG. 2, Platform 110 may comprise a server, which may include server-type capabilities. Thus, the Platform 110 may operate under the Software as a Service concept, so that the system is scalable and may host any number of users and OS App Compatible Devices, and may communicate with one or more Application Stores without changing the functionalities of the Platform 110.

Smartphone 130 is a mobile telephone that includes any one or all of the following functionalities: computing capabilities akin to a personal computer (PC); personal digital assistant (PDA) functionality; and Internet browsing functionality. As shown in FIG. 1, smartphone 130 may communicate with Platform 110 via the Internet 120 by communicating wirelessly with cellular network 160 wirelessly and using gateway server 160 or through Wi-Fi router 180.

Tablet PC 140 is another portable computing device that may communicate with Platform 110. Tablet PC 140 is typically slate- or tablet-shaped and equipped with a touchscreen or stylus. Tablet PC 140 may communicate with Platform 110, using mobile network 160 and gateway server 170 to communicate via the Internet 120 (such as when Tablet PC 140 is mobile), through Wi-Fi router 180, or directly via the Internet 120 (such as when Tablet PC 140 is docked). Desktop computer 150 is another example of a computing device that may communicate with Platform 110. Platform 110 may also communicate with one or more Application Stores 190, and with any OS App Compatible Device 195.

FIG. 2 illustrates one example of an expanded block diagram of Platform 110. Platform 110 includes a processor 202 and a memory device 204. Processor 202 may comprise any type of controller, such as a microprocessor, a microcontroller, a digital signal processor, an application specific integrated circuit (ASIC), a field programmable gate array, a logical digital circuit, or other now known or later developed logical processing capability.

Platform 110 may comprise a single computer (with a single processor and a single memory device, such as depicted in FIG. 2). Alternatively, Platform 110 may comprise multiple computers working in combination with multiple memory devices (such as multiple databases). For example, various functionalities of the Platform 110, as discussed below, may be divided amongst different computers.

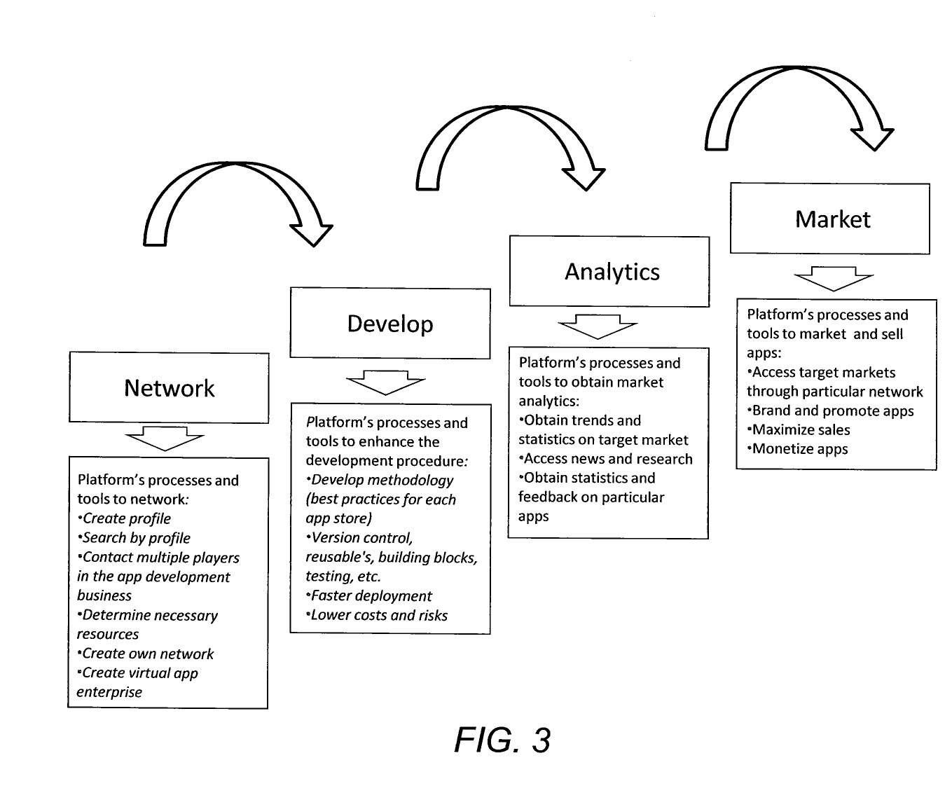

The memory 204 may store data for operation of the Platform 110. For example, memory 204 may include platform software 208, which when executed by the processor 202 performs various functionalities that the Platform 110 performs, such as the functionalities disclosed in FIGS. 3-8. Further, memory 204 may store profiles 206, which are data associated with users of the Platform 110, as discussed in more detail below. Memory 204 may also include Apps for sale 210 and Apps in development 212, as discussed below. Memory 204 may further include analytics algorithms 214, monetization tools 216, and development tools for diverse OSs 218. The examples of the data stored in memory 204 are merely for illustration purposes. It is contemplated that memory 204 may store other types of data. Further, memory 204 is illustrated as a single memory. Alternatively, memory 204 may include one or more databases to store different portions of data.

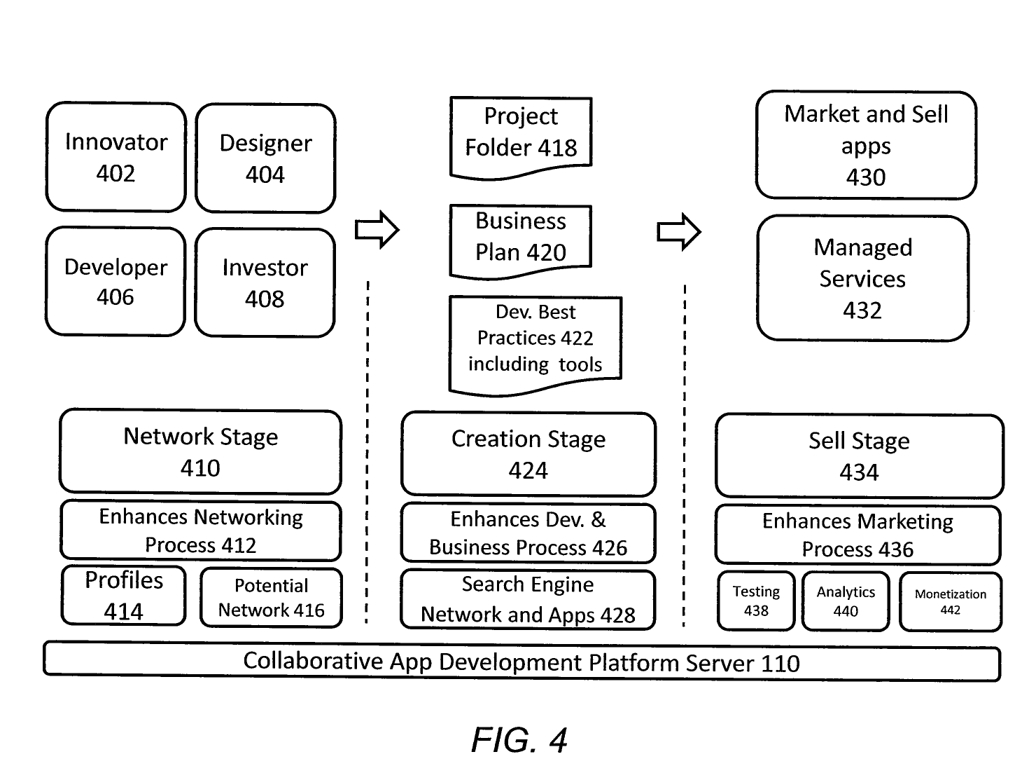

Analytics algorithms 214 may receive app data associated with the app. The app data may include performance data of the app, usage data, or any customizable event associated with the app that is sought for tracking. Further, part of the app running on the electronic device may generate the app data, which may relate to demographic, geographic and user interest data. One example of a methodology is using Flurry Analytics (see www.flurry.com), which places a lightweight agent into an application, so that performance data are tracked, logged and reported back for analysis. This information may be sent to the Platform 110, which may analyze the app data using analytics algorithms 214, and provide the resulting analysis only to the developer (or other members of the virtual app development team). In this way, the virtual app development team may receive metrics around usage behavior, any custom event chosen to be tracked and technical information about the device, firmware version, carrier, etc. The app data may be analyzed during the analytics phase, as illustrated in FIG. 3, or in the marketing phase, as illustrated in FIG. 4.

The Platform 110 is designed to assist in the various stages of the App life cycle, including idea development, app development, app analytics, and app marketing/sale/monetization. For example, the Platform 110 may: connect some or all of the parties involved in the process of creating and/or marketing an app; provide the means by which to establish agreements to develop the app; provide the main tools, knowledge bases and best practices for developing apps on one or more platforms; create an efficient supply of the different application stores; provide analytical information enabling the identification of trends and facilitate decision-making process; create an efficient process of promoting and marketing apps; and reduce the time-to-market of an app.

FIG. 3 is an illustration of the business model value chain for an app. One stage of the app life cycle is networking. The Platform 110, through its databases and software (such as illustrated in FIG. 2), assists in networking in several ways including: creating a profile; searching by profile; contacting one or more players in the app development process; creating a tailored or specific network; creating a virtual team formed by one or more entrepreneurs, designers, developers, investors, enterprises, testers, consumers, and any other person involved in the development of an app; and promoting one's previous app development and request other participants to assist in an app development project. The Platform 110 provides the forum in which the various parties involved in various stages of the App life cycle may communicate. In one embodiment, the Platform 110 may use social network type services to enable the various parties to communicate. For example, the Platform 110 may bring together investors, innovators, designers, developers, testers, enterprises, consumers and/or any other person involved in the development of an app, for the development and marketing of apps. Similar to a social networking service, the Platform 110 enables a representation of users (which may comprise a profile), his/her social links, and a variety of services that the user may provide related to an app. As discussed in more detail below, the Platform 110 may be web-based and provide means for users to interact over the Internet 120, such as e-mail, instant messaging, or Twitter. More specifically, the Platform 110 may provide the basis for users to: create a profile (discussed below); post entries (such as blog or microblog entries) for other users to read; search other users' profiles; compile/share lists of contacts; create groups related to app development; and hold discussion forums.

Alternatively, the Platform 110 may be used to create virtual teams for any type of project (which may be different from the project of developing an app). For example, the Platform 110 may be used for a web-page development project, an engineering project (such as developing and marketing a consumer electronics product, e.g., a smartphone), or any other type of collaborative effort that includes any one or more investors, innovators, designers, developers, testers, or any other person involved in such development.

In this way, the users, using the Platform 110, may enter user input, via smartphone 130, tablet PC 140, desktop computer 150, or any other OS App Compatible Device 195, and send the user input via the Internet 120 to the Platform 110. The user input may include one or more aspects searchable in the profiles (discussed below). The Platform 110 may search the profiles and send to the users one or more profiles that match the user input. The search results may be sorted by relevance, such as pre-defined criteria of relevance or a user-designated ranking of relevance. Criteria may include, but is not limited to: number of apps person has worked on; number of apps person has developed through the Platform 110; is the person qualified according to the Platform 110; positive/negative opinions of person from other members of the Platform 110; total amount of monetization for all of the apps person has worked on; average monetization per apps person has worked on; etc. The user may then send invitations to other users associated with the one or more profiles matched. And, those that received the invitations may respond (such as accepting or rejecting the invitation to join a virtual app development team). For those who accept, the Platform 110 may create a virtual app development team. Further, as discussed below, the Platform 110 may create a section in memory (such as a project folder) that is accessible by the virtual app development team for development of the app.

For example, the user may send an e-mail (or other type of communication) to the users if the e-mail (or other contact information) is contained within the profile. As another example, the user may request the Platform 110 to send the communication to the users if the e-mail (or other contact information) is not publicly available in the profile. The users of the Platform 110 may thus communicate with one another in order to come to an agreement to develop an app or to share thoughts regarding an app idea or project.

The Platform 110 may send a commercial agreement to the members of the virtual app development team. One, some, or all of the members of the virtual app development team provide commercial agreement input. The commercial agreement input may include an acceptance of all of the terms of the commercial agreement sent from the Platform 110. Or, the commercial agreement input may include an amendment to one of the terms of the commercial agreement sent from the Platform 110. Alternatively, the commercial agreement input may include an additional term (or terms) to the commercial agreement sent from the Platform 110. The agreement may include terms for development of the app (such as timing and contributions of the users) and include terms for sharing of revenue or pay a fixed fee. As discussed in more detail below, the Platform may receive these terms and create an agreement for the development of the app. In this way, the Platform 110 may facilitate the creation of a network for developing an app or, similarly, for the creation of a virtual team for the development or execution of diverse projects different than apps.

The commercial agreement may comprise a standard agreement that includes standardized terms. For example, the commercial agreement may include an entirely completed commercial agreement (including all of the terms filled in associated with apportioning the revenues from the sale of the apps). In this instance, one, some, or all of the members of the virtual app development team may accept all of the terms of the commercial agreement so that the virtual app development team commercial agreement is identical to the standard commercial agreement. As another example, the commercial agreement may include a partially completed commercial agreement (with certain parts unfilled, such as the percentage apportioning of the revenues from the sale of the apps being left blank). In this instance, one, some, or all of the members of the virtual app development team may fill in the terms of the partially completed agreement (such as amounts to indicate the division of revenues from the sale of the app) so that the virtual app development team commercial agreement includes the filled in terms (including the amounts to indicate the division of revenues from the sale of the app). In this example, the virtual app development team commercial agreement is based on, but not identical to, the standard commercial agreement. In implementing the agreement, when revenue is received from one or more sales of the app, the revenue is distributed to the virtual app development team based on the terms of the virtual app development team commercial agreement. Further, the commercial agreement may be amongst various members of the virtual app development team and/or the Platform 110. For example, the virtual app development team may include an administrator, who may oversee the virtual app development team. In one embodiment, the Platform 110 may assist in generating agreements between the administrator, the Platform and each of the participants in the team (e.g., 1 agreement between the Administrator and the Platform, 1 agreement between the Administrator and team member 1, 1 agreement between the Administrator and team member 2, etc.). In an alternative embodiment, the Platform 110 may assist in generating a single agreement between the administrator, the Platform and each of the participants in the team.

From a practical standpoint, users may be situated in various locations around the world. The Platform, with its social networking services, allows the various users to communicate, enables users from around the world to form groups or teams for app development. For example, the investor may be located in Europe, the innovator may be located in Japan, the designer may be located in the United States, and the developer may be located in Mexico. The Platform 110 thus provides the forum through which different parties, who may not have had a previous business relationship, can connect with one another in order to create a team for app development.

A second stage in the app life cycle is developing the app. As discussed in more detail below, the Platform 110 includes processes and tools to enhance or assist the development of the app including: developing methodology (such as best practices); version control; building blocks; testing; faster deployment with analytics (such as analytics algorithms 214) enabling the Platform 110 to gather and provide the users with one or more recommendations (such as trends, most wanted features, etc.); lower costs and risks with the analytics (such as analytics algorithms 214) providing users with information to assist in development.

A third stage in the app life cycle is analytics. As discussed in more detail below, the Platform 110 includes processes and tools to obtain market analytics including: obtaining trends and statistics on target market; accessing news and research; obtain statistics and feedback on particular apps. Analytics, such ones presented as a result of running analytics algorithms 214, may thus be provided to users who use Managed App Services and to other users (though at a more basic level).

A fourth stage in the app life cycle is marketing. As discussed in more detail below, the Platform 110 includes processes and tools to market and sell apps including: accessing target markets through one or more networks; branding and promoting apps; and monetization (such as by using an embedded code that allows apps to be used as advertising platforms, thereby displaying ads instructed to be posted by the Platform 110 in the various OS App Compatible Devices). In this way, the platform may serve as an intermediary between supply and demand, so supply will be based on the demand placed on the Platform 110, benefiting providers of apps and consumers in general. This is unlike prior app development in which developers worked freelance to launch apps based on their programming abilities and not based on the market's needs

FIG. 4 is an expansion of various stages of the app life cycle. Various parties may contribute to the different states of the app life cycle including: the innovator 402; the designer 404; the developer 406; and the investor 408 the above 402, 404, 406 and 408 may additionally include any other person involved in the development of an app. The innovator 402 is typically a generator of ideas for an app. The designer 404 is the person who structurally and/or visually designs an app. The developer 406 is typically the person who programs and/or codes an app. The investor 408 is typically one who actively sponsors at least one project for developing an app. FIG. 4 shows one of each of the innovator 402, the designer 404, the developer 406, and the investor 408. This is for illustration purposes only. Any number of innovators, designers, developers and investors or any other parties involved in the development of an app are contemplated. Moreover, one participant may have one or more roles. For example, the innovator may also have the role of developer.

The Platform 110 assists the innovator by enabling the innovator to: post or publish to submit ideas for discussion (whether publicly or privately); assess the feasibility of an idea according to the reading of analytics provided by the Platform 110 (e.g., the Platform 110 may indicate trends or averages of apps so that the innovator may generate an informed business plan based on hard data, not mere supposition. More specifically, depending on the type of app, the Platform 110, through Analytics Algorithms 214, may provide guidelines as to the amount to charge for the app and the number of expected sales for the app given other similarly situated types of apps developed using the Platform 110, thereby assisting in development of the business plan); invite people to review and rank an innovator's idea; and accept/reject requests from users who want to see the innovator's idea (after which, the innovator may become the administrator of the App development project). Further, as discussed below, the Platform 110 provides the legal and commercial framework for development of the app, thereby assisting the innovator.

The Platform 110 assists the investor by enabling the investor to: review of existing ideas; blocking of existing ideas (the ability of the Platform 110 to set aside one or more ideas for the investor to review; this functionality is akin to a shopping cart whereby the Platform 110 temporarily sets aside a specific idea in order to provide time for the investor to reach agreement with the innovator; if nothing is agreed with the innovator, the idea may be released automatically within a predetermined time by the creator; alternatively, the idea may be blocked depending on market acceptance and the decision to deploy the idea); assess the viability of ideas based on a reading of analytics provided through the Analytics Algorithms 214, by the Platform 110 (e.g., the Platform 110 may provide current trends and averages of the App market, thereby providing more certainty for investors to fund specific projects); and send notifications to the originator of the idea. In this way, the investor does not necessarily need to have a large capital outlay to invest or a robust team assessing the projects. Rather, the Platform 110 provides access to opportunities for the investor that are not available in traditional app development.

The Platform 110 further assists the developer by enabling the developer to: track and generate statistics for an app (e.g., the developer is given a tracking code to insert into the app to track and to generate statistics of the same); receive a report of the statistics of the app resulting from the reading of the tracking code and running them through the Analytics Algorithms 214, (the statistics include, without limitation, buyer demographics; frequency of use; minutes consumed in the app; possible error(s); download price; total number of downloads; UI rating; hardware used to download; identification of opportunities for upgrading, monetization or support)

In addition to the project management of the development of the app project, the Platform 110 may provide to the designer or developer building blocks, APIs, and/or other tools for development.

The Platform 110 assists in the network stage 410 of app development by enhancing the networking process 412. One way is to include profiles 414 for one, some, or each of the users of the Platform 110. The Platform 110 enables the following tailored aspects of the profile including: ability to post or publish information, CV, experience, interests, etc. (such as text, images, video and files); wall informative or wall; ability to designate their genre or favorite genres for apps (such as sports apps, finance apps, lifestyle apps, etc.); ability to post or publish status (such as “Developer with skill in the XX, currently involved in 3 projects” or “Freelancer with X skill available/not available”); ability to post a “looking for” a particular user or particular ability (such as looking for developers, ideas, investors, designers, UI experts, and/or a particular type of apps). The examples of the tailored aspects of the profile are for illustration purposes only. Other aspects of the profile are contemplated.

The Platform 110 also provides the ability to create a potential network 416 by using various options related to social networking including: ability to post or publish ideas or projects related to apps and the ability to search for people/companies for particular skills, experience, interests, affinities, etc.; ability to invite people to the Platform 110; ability to create Groups (such as virtual teams of investors, innovators, designers, developers, and any other person involved in the development of an app); ability to upload their own apps (developed within or outside of the Platform 110); ability to join and access newsletters or other news; ability to access knowledge database platform, tools and project folders; ability to follow-up with other users; ability to rank ideas, projects or apps; ability to participate in ideas or projects through the authorization of the host or the administrator; ability to automatically update the profile depending on their interaction within the Platform 110; ability to chat with other users; ability to rank users and searches by the degree of complexity of a profile and connectivity according to a programmed algorithm; ability to provide privacy management, so that each user may decide whether other members of their networks or the wider community can access or know his or her profile.

For example, the Platform 110 enables a user (such as an innovator) to create and share ideas with other users (such as the rest of the community). In response, the community may rate (or rank) the ideas or bid on the ideas in order to participate in the development of the idea; ideas may be ranked by the Platform pursuant to a programmable algorithm, based on relevance of each user's trends. In particular, in response to an innovator posting an idea, a developer or a designer may submit a bid to bring a skill necessary to achieve the idea. As another example, in response to an innovator posting an idea, an investor may submit a bid to provide a contribution or other means for revenue to pay for the development of the app (such as a project development fund). In this way, the users of the Platform 110 may create a network that is tailored to the users' particular needs in developing an app.

As another example, the innovator may use the Platform 110 to search different profiles for a designer, a developer, an investor, and/or any other person involved in the development of an app; profiles may be ranked by the Platform pursuant to a programmable algorithm, based on relevance of the user's needs. Based on the searches, the innovator may select a particular designer, a particular developer, a particular investor and/or any other particular person involved in the development of the app. The innovator may then send messages to the particular designer, the particular developer, the particular investor, and/or any other particular person involved in the development of the app. In this way, the Platform 110 enables the formation of relationships relevant to the development of an app.

Upon agreement between an innovator and one or more of the designer, developer, investor, and/or any other particular person involved in the development of the app the creation stage 424 is entered. In the creation stage, a project folder 418 is created. The project folder 418 is a system tool for the innovator to perform part or all of the project on the Platform 110. The project folder 418 may be divided into sub-folders, such as a business sub-folder (which may include a business plan 420) and a developer sub-folder (which may include development best practices 422, tools, actual coding of the App and version control, among others).

The business sub-folder provides the legal and commercial documentation that serves as a basis for the formal creation of the project. The documentation may be preloaded with formats that enable building of relationships of trust with other participants in the process. The business sub-folder provides the means by which the participants to the project agree to the division of profits. For example, the business sub-folder may include a display screen by which the participants may negotiate and agree to the amounts of shares or compensation allotted (such as, for example, the percentages of profits allotted to each of the innovator, designer, developer, investor, and/or any other particular person involved in the development of the app). After agreement, the amounts of shares may be translated into a formal agreement for the participants to sign. In this way, the business sub-folder of the Platform 110 enables the various participants (such as innovator, designer, developer, investors, and any other person involved in the development of the app) the forum through which to agree on the share amounts, and enables the recording of the agreed share amounts into formal agreements, thereby assisting in the development of the app. Similar to the Platform 110 enabling the formation of networks (using social networking type of searches), the Platform 110 also assists in the formation of agreements once the networks are formed.

One participant may be designated as the project leader or the administrator. Typically, the innovator 402 is designated as the project leader. The project leader has the ability to include new participants to the project or to eliminate participants to the project, which ability might be also subject to final approval percentage share amounts. The project leader may be able to modify the compensation amounts, which ability might be subject to approval of, at least, the other party whose compensation was modified. Again, the Platform 110 may translate the agreed-to modifications into modified formal agreements. Modifications of the agreement may or may not require approval. In one embodiment, approval for modifications may depend on whether the modification affects a single member to the agreement, or affects all of the members to the agreement. If the modification affects one member to the agreement, approval may be obtained by less than all members to the agreement (such as only the Administrator to the agreement) prior to allowing the modification. If the modification affects all members to the agreement, approval may be obtained by a majority of the members to the agreement prior to allowing the modification.

The Platform 110 enhances development & business practices 426 by providing a standardized method by which users can be able to develop, market, and sell apps with more certainty due to a standardized process, an example of which is described herein. The search engine network and apps 428 may include functionality to search individuals, projects, or specific apps.

The project folder also allows for monitoring the project that will be either a Task Manager's work to do or an Administrator's. The Platform 110 may schedule tasks and report progress on the tasks in order to generate certain deliverables and identify if there are delays.

The project folder may also include the developer sub-folder. The developer sub-folder may contain the code, components, documents, rules, developer tools (discussed subsequently) and other materials to strengthen the process of developing an app. Source files may be loaded, with different versions tracked, and with the maximum average storage quota set (which may be extended by user request with justification and approved by the system administrator).

After development of the app, the sell stage 434 is entered. The Platform 110 may market and sell apps 430. In one aspect, the Platform 110 may provide Managed App Services. Specifically, when a project has passed the selection process and users agree on the amount of participation, one may optionally choose Managed App Services, which comprises the Platform 110 monitoring the project in a timely manner, distributing the app and marketing the app (such as the Platform 110 performing searches to determine users having an interest in the category of the app, and alerting the determined users of a new app that may interest them).

The apps developed through Managed App Services may be sold in application stores (such as the Apple® App Store, Android® Market, etc.) directly by, or with the recommendation of the Platform 110. The Platform 110 may upload an app 806, receive revenues from sales 808 and may distribute the revenues among the participants according to the amounts agreed in the creation of the project 810. Alternatively or in addition, the apps may be sold by the Platform 110 itself or uploaded to an application store.

The Platform 110 may enhance the marketing process 436, such as by testing 438 and by providing the participants with analytics 440 result of running Analytics Algorithms 214 and by providing monetizing codes 442 for the apps to become an advertising platform. In particular, the Platform 110, with Analytics 440 obtained through Analytics Algorithms 214, may select which users to target marketing, when to target the users, and how to target the users. For example, the Platform 110 may determine a type of app (such as a lifestyle app), and promote the app using the profiles of users. In particular, the Platform 110 may search for various aspects in the profiles (such as an indication of interest in lifestyle apps in the profile) to determine whether there is an indication in the profile of potential interest in the app. If so, the Platform 110 may send a notification (such as an e-mail or other type of notification) to the person associated with the profile. Further, the Platform 110 may determine when to send the notification (such as at a designated time of day when the person is typically using his or her device). As another example, the Platform 110 may generate reports based on analysis of the apps or use of the Platform 110. In particular, the Platform 110, through Analytics Algorithms 214, may analyze the tracking code inserted into the apps, which will determine the browser or OS App Compatible Device used, the number of users of the platform as a whole and/or profile, the total number of active projects and by category, status, progress percentage preferences, interests, abilities, sales generated, clicks per user, and average time. The information rendered is BI (Business Intelligence), which is important for decision-making.

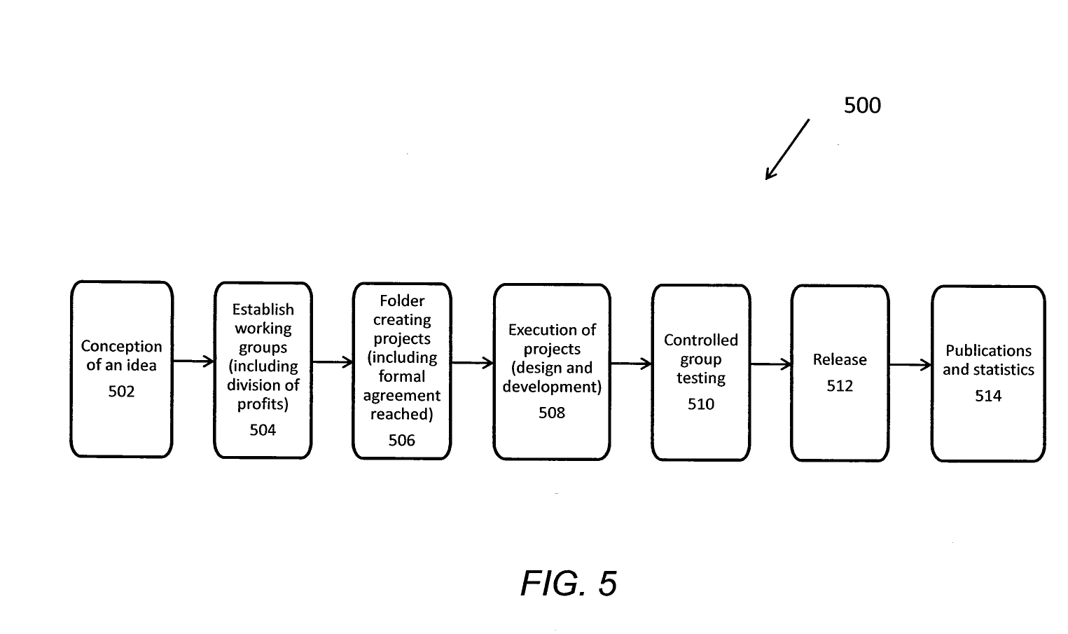

FIG. 5 is a high level flow chart 500 of various steps in the development and marketing of an app through the Collaborative App Development Platform Server. At 502, an innovator conceives of an idea. As discussed above, the idea may be posted to a message board (either private or public) on the Platform 110. In response to the posting, the innovator may receive responses, and thereafter at 504 establish working groups for the development of the idea. As discussed above, with its programmable custom search algorithms, the Platform facilitates in creating virtual teams with people who may be of diverse backgrounds (such as investors, innovators, designers, developers, and any other person involved in the development of an app) and may be in diverse locations (such as around the world). For example, the Platform may facilitate in creating the virtual teams by using social networking services to allow the various users to communicate. As another example, the Platform may provide one or more tools (such as providing revenue sharing agreements) to help the users create the virtual teams. At 506, one or more folders may be created for the projects to develop the idea. As discussed above, the one or more folders may provide the framework in which to develop the idea. At 508, execution of the one or more projects is performed, including design and development of the app. At 510, controlled group testing may be performed to test the app. After which, the app is released at 512. And, publications and statistics associated with the release may be generated at 514.

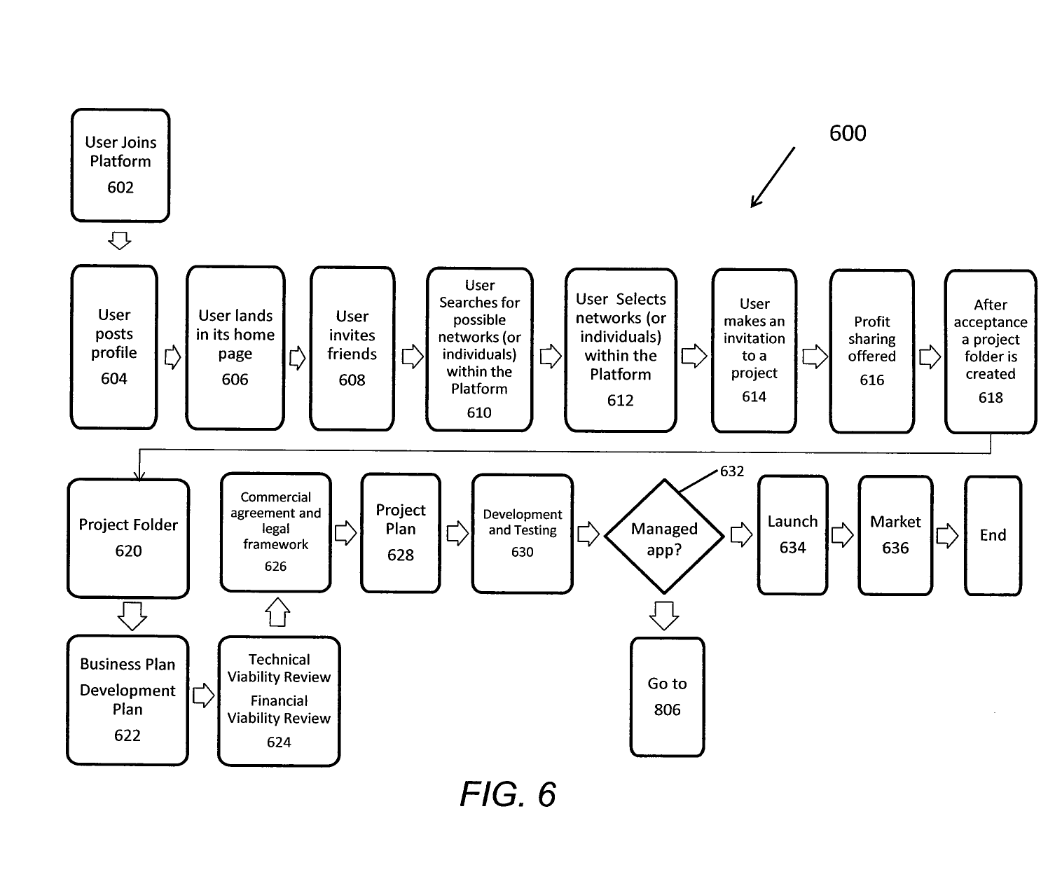

FIG. 6 is a more detailed flow chart 600 of the various steps in the development and marketing of an app. At 602, the user joins the Platform 110. In order to network with other user of the Platform 110, the user posts a profile at 604. The user may land in his/her home page at 606. As part of the networking process, the user may invite friends at 608 and/or perform searches of possible networks (or individuals) within the Platform 110 at 610. Alternatively or in addition, the Platform 110 may recommend potential contacts to develop an app. The recommendation by the Platform 110 may be based on the particular idea or based on the profile of the user.

Based on the various invitations and/or searches, the user may select one or more networks (or individuals) within the Platform 110 at 612. The user may make an invitation to a project at 614. For example, if the user is a designer, developer, investor, and/or any other person involved in the development of an app, the user may request or bid to work on an idea that is posted by an innovator. Alternatively, an innovator may post an idea and make invitations to work on the idea, or receive a request or feedback on the idea. The invitation by the user may contain general project details and a confidentiality notice. At 616, profit sharing for the project is offered. At 618, a project folder is created after acceptance of the profit sharing offered at 616. Moreover, at 620, the project folder may be accessed. The project folder may include any one or all of the following: list of the virtual team members; the task lists; the revenue sharing agreement; development tools (such as building blocks); and version control. And, at 622, a business plan and a development plan are generated. At 624, a technical viability review and a financial viability review related to app are generated by the participants with the help of the analytics algorithms 214 provided by the Platform 110. After these reviews, at 626, a commercial agreement and legal framework are created by the participants and an agreement is generated by the Platform 110. As discussed above, the Platform 110 is able to facilitate the interaction between the various parties (such as the innovator, designer, developer, investor, and/or any particular person involved in the development of an app) in order to agree on terms of the division of profits from the sale of the app and terms of responsibility in developing/marketing the app. Once the terms are agreed-to, the Platform 110 may generate the formal agreements necessary to give effect to the agreements reached between the various parties. For example, the Platform 110 may provide a forum for the various parties to fill in. Based on the answers to the form, the Platform 110 may generate the agreement(s).

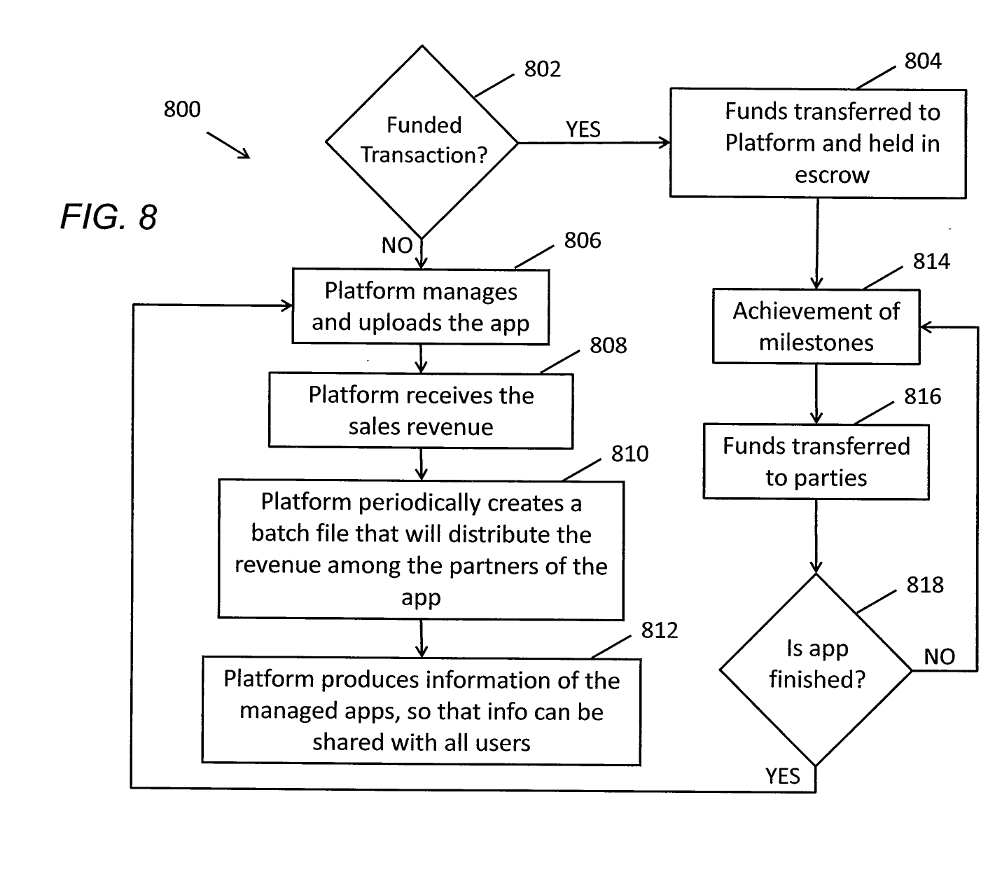

At 628, a project plan for the development/testing of the app is developed, and following the project plan, the app is developed and tested at 630. At 632, it is determined whether the app is to be managed by the Platform 110 through Managed App Services. If so, the flow diagram 600 moves to block 806 of FIG. 8. After development and testing, the app is launched at 634. Moreover, the app is marketed at 636. As generally discussed above, the Platform 110 may be involved in the marketing of the app, such as with little user input or no user input (automatically), searching for potential users that may be interested in the app and providing the list of users of the Platform 110 that may be interested in the app. For example, the Platform 110 may notify a particular app to a selected network, category or all members of the Platform community.

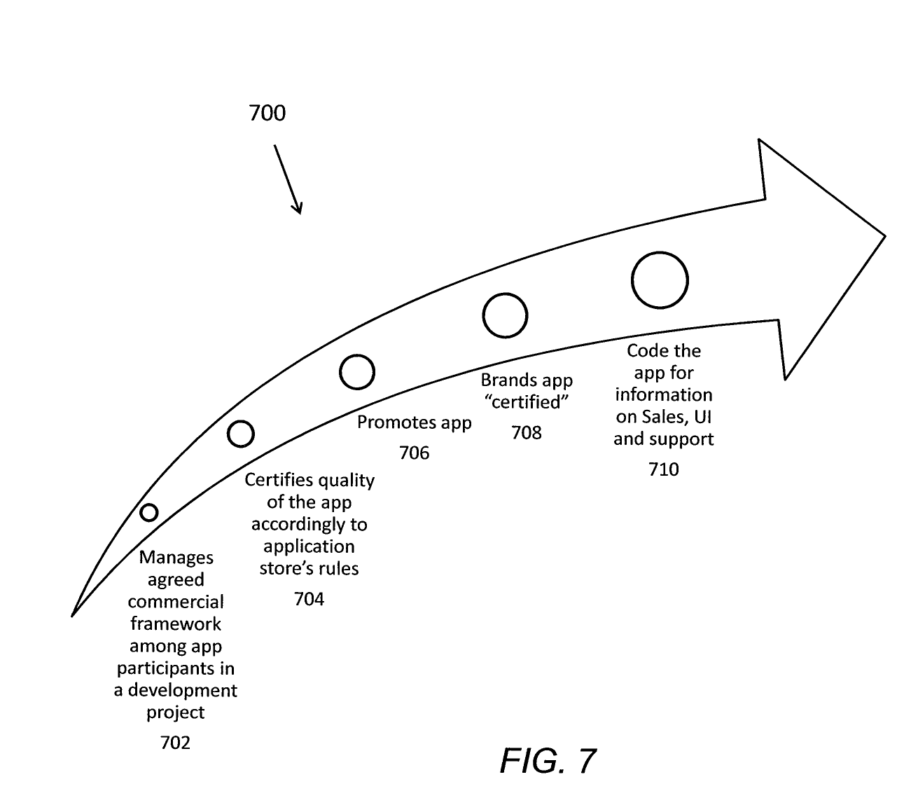

FIG. 7 is an illustration of various functions that the Platform 110 may perform when selecting Managed Apps (such services “Managed Services”). The various functions may be interrelated to one another. At 702, the Platform 110, when requested to do so, manages the agreed commercial framework among app participants in a development project. As discussed above, the Platform 110 enables communication between parties (such as by social networking type communications) in order for the parties to come to an agreement. After the parties agree to the division of profits, the Platform 110 may then reduce the agreement (including the division of profits) into a formal commercial agreement, including various milestones in development of the app and distribution of profits from sale of the app. In one embodiment, the Platform 110 may manage milestones associated with the agreement. For example, in the event that the app is funded with a certified fund, the Platform 110, in addition to handling the proceeds derived from the sale of the app, can manage disbursement of the funds committed by the investor(s) when the development team reaches milestone(s). Thus, after generating the formal commercial agreement, the Platform 110 may provide the basis by which to manage the commercial framework, including managing milestones in the development of the app.

At 704, the Platform 110 may certify the quality of the app according to the specific Application Store rules applicable for the OS on which the App was developed. At 706, the Platform 110 may promote the app. As discussed above, the Platform 110 may use social network type communications in order to promote the app. At 708, the Platform 110, when Managed App Services is selected, may brand the app “certified”. Again, the promotion of the app and the certification of the app are each related to the marketing of the app. At 710, the Platform 110, when Managed App Services is selected, may code the app for information on sales, UI and support. As shown in FIG. 6, the flow chart 600 continues at 806 when the app is a funded app.

FIG. 8 is a flow diagram 800 of revenue management for apps managed through Managed App Services and optionally funded by the Platform 110 or by a certified-by-the-platform investor. For apps managed through Managed App Services by the Platform 110, the Platform 110 may produce a certificate at a predetermined time (such as monthly) of the revenue spread to each partner. For each funded app, the Platform 110 may send an invoice of the funding management fee to the team members, at launching to application store, with the funding fee being a fixed amount or a share in the proceeds of selling the app. Once an app managed through Managed App Services is launched, the platform will follow its behavior in the application store so the information of the app can be shared with the community. The Platform 110 may also provide info of the funded apps, sorting them by project status.

As shown in FIG. 8, the Platform 110 may be involved in the management and/or funding of the app in one of several ways. In particular, the Platform 110 may manage one or more transactions related to the app. For example, at 802, if it is determined that the Platform 110 has not funded the transaction, the flow chart 800 moves to 806 to upload the app to the online store. Once the app is uploaded, the Platform 110 may manage the revenue, such as receiving the sales revenue at 808. Received income from sales of the app may be distributed by the Platform 110 according to the previously agreed commercial agreement. At 810, the Platform 110 may create a batch file able to periodically send instructions to the bank regarding the spread of the revenue. Thus, in addition to providing the means through which to create virtual teams, the means through which to facilitate development and testing of an app, the Platform 110 further provides the means through which the income may be distributed. At 812, the Platform 110 may also produce information of the apps managed through Managed App Services, so that the info can be shared with all users (such as the innovator, designer, developer, investor, and any other person involved in the development of an app).

If the app is funded by the Platform 110 or by a certified-by-the-platform investor, the flow chart 800 moves to 804 whereby funds are transferred to the Platform 110 and held in escrow or transferred to the Platform 110 to be applied to specific projects when milestones are reached. When a transaction is funded by the Platform 110 or by a certified-by-the-platform investor, the money committed and funded by the Platform 110 to the participants may be managed and transferred by the Platform 110 after the achievement of the milestones defined in the development process (discussed above). For example, as shown in FIG. 8, at 814, achievement of milestones results in funds being transferred to the parties at 816. At 818, it is determined whether the development of the app is finished. If so, the flow chart 800 moves to 806 and is the same as when the transactions are managed by the Platform 110.

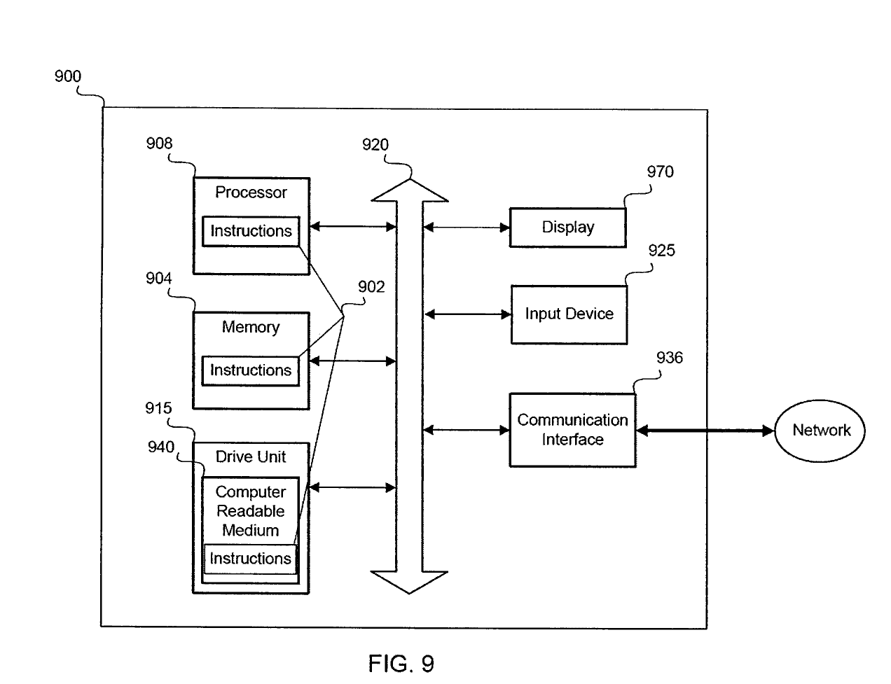

FIG. 9 illustrates a general computer system 900, programmable to be a specific computer system, which may represent Collaborative App Development Platform Server 110, smartphone 130, Tablet PC 140, Desktop Computer 150, Gateway Server 170, Application Store 190, and OS App Compatible Device 195, or any other computing devices referenced herein or that may be executed by or with Collaborative App Development Platform Server 110. FIGS. 5-8 illustrate flow or sequence diagrams, all of which may be implemented on the general computer system 900 as illustrated in FIG. 9. FIG. 2 illustrates an expanded block diagram of the Collaborative App Development Platform Server 110. The computer system 900 may include an ordered listing of a set of instructions 902 that may be executed to cause the computer system 900 to perform any one or more of the methods or computer-based functions disclosed herein. The computer system 900 may operate as a stand-alone device or may be connected, e.g., using one or more networks as illustrated in Figure, to other computer systems or peripheral devices.

In a networked deployment, the computer system 900 may operate in the capacity of a server or as a client-user computer in a server-client user network environment, or as a peer computer system in a peer-to-peer (or distributed) network environment. The computer system 900 may also be implemented as or incorporated into various devices, such as a personal computer or a mobile computing device capable of executing a set of instructions 902 that specify actions to be taken by that machine, including and not limited to, accessing the Internet or Web through any form of browser. Further, each of the systems described may include any collection of sub-systems that individually or jointly execute a set, or multiple sets, of instructions to perform one or more computer functions.

The computer system 900 may include a memory 904 on a bus 920 for communicating information. Code operable to cause the computer system to perform any of the acts or operations described herein may be stored in the memory 904. The memory 904 may be a random-access memory, read-only memory, programmable memory, hard disk drive or any other type of volatile or non-volatile memory or storage device.

The computer system 900 may include a processor 908, such as a central processing unit (CPU) and/or a graphics processing unit (GPU). The processor 908 may include one or more general processors, digital signal processors, application specific integrated circuits, field programmable gate arrays, digital circuits, optical circuits, analog circuits, combinations thereof, or other now known or later-developed devices for analyzing and processing data. The processor 908 may implement the set of instructions 902 or other software program, such as manually-programmed or computer-generated code for implementing logical functions. The logical function or any system element described may, among other functions, process and/or convert an analog data source such as an analog electrical, audio, or video signal, or a combination thereof, to a digital data source for audio-visual purposes or other digital processing purposes such as for compatibility for computer processing.

The computer system 900 may also include a disk or optical drive unit 915. The disk drive unit 915 may include a computer-readable medium 940 in which one or more sets of instructions 902, e.g., software, can be embedded. Further, the instructions 902 may perform one or more of the operations as described herein. The instructions 902 may reside completely, or at least partially, within the memory 904 and/or within the processor 908 during execution by the computer system 900. Accordingly, memory 204 described above in FIG. 2 may be stored in the memory 904 and/or the disk unit 915.

The memory 904 and the processor 908 also may include computer-readable media as discussed above. A “computer-readable medium,” “computer-readable storage medium,” “machine readable medium,” “propagated-signal medium,” and/or “signal-bearing medium” may include any device that includes, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium.

Additionally, the computer system 900 may include an input device 925, such as a keyboard or mouse, configured for a user to interact with any of the components of system 900. It may further include a display 970, such as a liquid crystal display (LCD), a cathode ray tube (CRT), or any other display suitable for conveying information. The display 970 may act as an interface for the user to see the functioning of the processor 908, or specifically as an interface with the software stored in the memory 904 or the drive unit 915.

The computer system 900 may include a communication interface 936 that enables communications via the communications networks illustrated in FIG. 1. The communications networks illustrated in FIG. 1 may include wired networks, wireless networks, or combinations thereof. The communication interface 936 network may enable communications via any number of communication standards, such as 802.11, 802.17, 802.20, WiMax, 802.15.4, cellular telephone standards, or other communication standards. Simply because one of these standards is listed does not mean any one is preferred as any number of these standards may never actually be adopted in a commercial product.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein. Such a programmed computer may be considered a special-purpose computer.

The method and system may also be embedded in a computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present embodiments are to be determined by the broadest permissible interpretation of the following claims and their equivalents, and shall not be restricted or limited by the foregoing detailed description. While various embodiments have been described, it will be apparent to those of ordinary skill in the art that many more embodiments and implementations are possible within the scope of the above detailed description. Accordingly, the embodiments are not to be restricted except in light of the attached claims and their equivalents.

1. A server comprising:
a memory configured to store profiles for one or more of innovators, entrepreneurs, developers, consumers, enterprises, investors, and any other person involved in the development of an app, the profiles including data for a respective innovator, developer, investor or any other particular person involved in the development of an app;
a network communication interface configured to receive communications with one or more electronic devices; and
a controller in communication with the memory and the network communication interface, and configured to:
receive user input from users of the electronic devices, the user input indicative of requests for searches of the stored profiles;
send results of the searches of the stored profiles to the users of the electronic devices according to one or more predetermined criteria;
receive requests from the users to send invitations to other users to join a virtual app development team;
send invitations to the other users to join the virtual app development team;
receive acceptance information from one or more of the other users;
create a virtual app development team based on the acceptance information; and
configure a section in the memory accessible to the virtual app development team and dedicated for development of an app.

2. The server of claim 1, wherein the processor is further configured to make accessible one or more app development tools for development of the app.

3. The server of claim 1, wherein the processor is further configured to:
analyze app data to determine one or more trends, the app data comprising performance data of the app or usage data of the app; and
report the determined one or more trends to the virtual app development team.

4. The server of claim 1, wherein the processor is further configured to:
make a commercial agreement available to at least one user in the virtual app development team; and
receive commercial agreement input in order to generate a virtual app development team commercial agreement for the virtual app development team to develop and market the app.

5. The server of claim 4, wherein the commercial agreement comprises a standard agreement; and
wherein controller is configured to generate the virtual app development team commercial agreement based on the commercial agreement and the commercial agreement input.

6. The server of claim 5, wherein the commercial agreement input includes amounts indicative of division of revenues from sale of the app; and
wherein the virtual app development team commercial agreement includes terms based on the amounts indicative of division of revenues from sale of the app.

7. The server of claim 6, wherein the controller is further configured to:
receive revenue from sales of the app; and
distribute the revenue to the virtual app development team based on the terms of the virtual app development team commercial agreement.

8. The server of claim 6, wherein the controller is further configured to:
release funding for development of the app;
determine or help determine whether one or more milestones in the commercial agreement have been met; and
transfer funds according to the commercial agreement if it is determined that the one or more milestones have been met.

9. The server of claim 1, wherein the section configured in the memory comprises a project folder for design and development of the app.

10. A method comprising:
receive user input from users of the electronic devices, the user input indicative of requests for searches of stored profiles, the stored profiles for one or more of innovators, entrepreneurs, developers, consumers, enterprises, investors, and any other person involved in the development of an app, the stored profiles including data for a respective innovator, developer investor or any other person involved in the development of an app;
sending results of the searches of the stored profiles to the users of the electronic devices according to one or more predetermined criteria;
receiving requests from the users to send invitations to other users to join a virtual app development team;
sending invitations to the other users to join the virtual app development team;
receiving acceptance information from one or more of the other users;
creating a virtual app development team based on the acceptance information; and
configuring a section in the memory accessible to the virtual app development team and dedicated for development of an app.

11. The method of claim 10, wherein the processor is further configured to make accessible one or more app development tools for development of the app.

12. The method of claim 10, further comprising:
analyzing app data to determine one or more trends, the app data comprising performance data of the app or usage data of the app; and
reporting the determined one or more trends to the virtual app development team.

13. The method of claim 10, further comprising:
making a commercial agreement available to at least one user in the virtual app development team; and
receiving commercial agreement input in order to generate a virtual app development team commercial agreement for the virtual app development team to develop and market the app.

14. The method of claim 13, wherein the commercial agreement comprises a standard agreement; and
wherein generating the virtual app development team commercial agreement is based on the commercial agreement and the commercial agreement input.

15. The method of claim 14, wherein the commercial agreement input includes amounts indicative of division of revenues from sale of the app; and
wherein the virtual app development team commercial agreement includes terms based on the amounts indicative of division of revenues from sale of the app.

16. The method of claim 15, further comprising:
receiving revenue from sales of the app; and
distributing the revenue to the virtual app development team based on the terms of the virtual app development team commercial agreement.

17. The method of claim 15, wherein further comprising:
releasing funding for development of the app;
determining or helping determine whether one or more milestones in the commercial agreement have been met; and
transferring funds according to the commercial agreement if it is determined that the one or more milestones have been met.

18. The method of claim 10, wherein the section configured in the memory comprises a project folder for design and development of the app.
